(19) United States
(12) Patent Application Publication
(10) Pub. No.: US 2008/0111916 A1
(43) Pub. Date: May 15, 2008

(54) Image de-interlacing method

(76) Inventor: Yu-Chang Wang, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/598,340

(22) Filed: Nov. 13, 2006

(51) Int. Cl. H04N 7/01

(52) U.S. Cl. 348/448

(57) ABSTRACT

An image de-interlacing method for estimating an interpolation luminance of an interpolated pixel improving interpolation quality of oblique lines comprises selecting a plurality of candidate interpolation directions extending from one of a plurality of first candidate interpolation pixels to one of a plurality of second candidate interpolation pixels respectively on top and bottom lines adjacent to the interpolated pixel, classifying the candidate interpolation directions with first candidate interpolation pixels located at the upper left, upper right, and upper middle of the second candidate interpolation pixel respectively into first, second, and third directional groups, and selecting one or all of the directional groups to obtain the interpolation luminance of the interpolated pixel according to whether regions around the interpolated are present in an ambiguous area of an oblique line, and if so, further according to direction type (and color type) of the oblique line.

### BACKGROUND OF THE INVENTION

1. Field of the Invention

The invention relates to an image de-interlacing method and more particularly to an image de-interlacing method improving interpolation quality of oblique lines.

2. Description of the Related Art

Progressive display devices display all lines of an image every refresh. In contrast, interlaced display devices, such as NTSC and PAL television displays, typically display images using even and odd line interlacing. To display interlaced video on a progressive display, video rendering systems have to generate pixel data for scan lines that are not received in time for the subsequent frame update. This interlace-to-progressive conversion process is referred to as de-interlacing. Current de-interlacing methods comprise intra-field de-interlacing, inter-field de-interlacing, and motion adaptive de-interlacing. The intra-field de-interlacing uses a single field to reconstruct one progressive frame and thus has half vertical resolution. Directional edge interpolation, also known as edge dependent interpolation (EDI) or edge-based line average (ELA) method, is the most popular algorithm in the intra-field de-interlacing domain.

FIG. 1 illustrates directional edge interpolation using a 5×3 window. An interlaced Line L_{I} includes interpolated pixels with unknown luminance requiring interpolation with known luminance of two candidate interpolation pixels selected from an upper line L_{U} and lower line L_{L}. If F is a current interpolated pixel with unknown luminance l(F) to be interpolated with luminance of pixels selected from candidate interpolation pixels A to E and G to K, then D₁, D₂, D₃, D₄, and D₅, respectively associated with directions [symbol] ₁, [symbol] ₂, [symbol] ₃, [symbol] ₄, and [symbol] ₅, represent directional differences around the current interpolated pixel F, defined as:

$${D}_{1} = \vert l ( A ) - l ( K ) \vert$$

$${D}_{2} = \vert l ( B ) - l ( J ) \vert$$

$${D}_{3} = \vert l ( C ) - l ( I ) \vert , \\ {D}_{4} = \vert l ( D ) - l ( H ) \vert$$

$${D}_{5} = \vert l ( E ) - l ( G ) \vert$$

where l(pixel name) denotes luminance of a pixel with the pixel name.

ELA uses the direction associated with the smallest difference Dₛ as the direction with highest correlation, where Dₛ is defined as:

Dₛ=min(D₁, D₂, D₃, D₄, D₅).

Since pixels on the direction associated with the smallest difference Dₛ are strongly correlated, the luminance l(F) of the current interpolated pixel F is approximated by interpolation of adjacent pixels on the direction. That is,

$$l ( F ) = \{ \begin{matrix}( l ( A ) + l ( K ) ) / 2 & if {D}_{s} = {D}_{1} \\ ( l ( B ) + l ( J ) ) / 2 & if {D}_{s} = {D}_{2} \\ ( l ( C ) + l ( I ) ) / 2 & if {D}_{s} = {D}_{3} \\ ( l ( D ) + l ( H ) ) / 2 & if {D}_{s} = {D}_{4} \\ ( l ( E ) + l ( G ) ) / 2 & if {D}_{s} = {D}_{5}\end{matrix} ,$$

where l(A) to l(K) denotes luminance of pixels A to K.

Although the ELA-based algorithm provides good performance in many cases, it has poor resolution recovery ability for oblique lines. White dots often spread in ambiguous areas of a recovered black oblique line or dark dots in ambiguous areas of a recovered white oblique line. FIG. 2A is an enlarged drawing of a black oblique line extending from lower left to upper right in a white background displayed in progressive mode to show such ambiguous areas 21-25 encountered in ELA method. As shown, since ambiguous areas 21-25 have higher luminance than the other regions of the black oblique line, interpolation luminance therein is thus higher if not many or even no candidate interpolation points on the right and lefts of the ambiguous areas 21-25 are selected. FIG. 2B is an exemplary image recovered using an ELA method. As shown in FIG. 2B, regions 201, 202 and 203 have many ambiguous areas having white dots.

To overcome this problem, the number of candidate interpolation directions is conventionally increased. However, this increases not only hardware costs but also probability of erroneous judgment on candidate interpolation direction with highest correlation, degrading quality of recovered images.

### BRIEF SUMMARY OF THE INVENTION

Accordingly, the invention provides an improved de-interlacing method preventing erroneous judgment on candidate interpolation direction with highest correlation in interpolation of oblique lines to improve quality of recovered oblique lines.

The invention provides an image de-interlacing method for estimating an interpolation luminance of an interpolated pixel, in which a plurality of candidate interpolation directions is selected, each extending from one of a plurality first candidate interpolation pixels to one of a plurality of second candidate interpolation pixels respectively on top and bottom lines adjacent to the interpolated pixel. Next, the candidate interpolation directions are classified into first, second, and third directional groups, wherein the first directional group comprises the candidate interpolation directions having the first candidate interpolation pixels located at the upper left of the second candidate interpolation pixels, the second directional group comprises the candidate interpolation directions having the first candidate interpolation pixels located at the upper right of the second candidate interpolation pixels, and the third directional group comprises the candidate interpolation directions having the first candidate interpolation pixels located at the upper middle of the second candidate interpolation pixels. Next, one or all of the directional groups obtains the interpolation luminance of the interpolated pixel according to whether a first observation region higher than the interpolated pixel and a second observation region lower than the interpolated are present in an ambiguous area of an oblique line, and if so, further according to whether the oblique line inclines from upper right to lower left (directional type 1) or from upper left to lower right (directional type 2). The first and second directional groups are selected to obtain the interpolation luminance of the interpolated pixel respectively if the first and second observation regions are present in an ambiguous area of an oblique line with directional type 1 and 2. All of the directional groups are selected to obtain the interpolation luminance of the interpolated pixel respectively if the first and second observation regions are not located in an ambiguous area of an oblique line.

Since not all of the candidate interpolation directions are always used to obtain the interpolation luminance of the interpolated pixel, erroneous judgment of the candidate interpolation direction with highest correlation can be greatly reduced for interpolation of oblique lines. Furthermore, fewer interpolation candidate interpolation directions can be used while interpolation quality is improved.

### BRIEF DESCRIPTION OF THE DRAWINGS

The invention can be more fully understood by reading the subsequent detailed description and examples with references made to the accompanying drawings, wherein:

FIG. 1 illustrates conventional directional edge interpolation using a 5×3 window;

FIGS. 2A and 2B are respectively an enlarged drawing of a black oblique line showing ambiguous areas encountered in an ELA method and an exemplary image recovered using an ELA method;

FIGS. 3A-3C are respectively an enlarged drawing of a black oblique line in a white background, a diagram illustrating luminance distribution of a region on any pixel line within the black oblique line of FIG. 3A, and a diagram illustrating luminance distribution of a region on any pixel line within a white oblique line;

FIG. 4 is a flowchart of an image de-interlacing method in accordance with a first embodiment of the invention;

FIGS. 5A and 5B respectively illustrate group partitioning and difference calculation of FIG. 4;

FIG. 6 illustrates line directional type analysis of FIG. 4;

FIGS. 7A-7D are enlarged drawings of ambiguous areas of oblique lines with all possible line types;

FIGS. 8A and 8B are flowcharts of image de-interlacing methods in accordance with a second and third embodiment of the invention respectively;

FIG. 9 is a flowchart of an image de-interlacing method in accordance with a fourth embodiment of the invention;

FIG. 10 is a flowchart of line type analysis of FIG. 9 in accordance with such an embodiment of the invention;

FIGS. 11A and 11B are flowcharts of image de-interlacing methods in accordance with a fifth and sixth embodiment of the invention respectively;

FIG. 12 is a flowchart illustrating modification process of a provisional interpolation luminance to interpolation luminance; and

FIG. 13 illustrates an image recovered using an image interpolation method of the invention; and

### DETAILED DESCRIPTION OF THE INVENTION

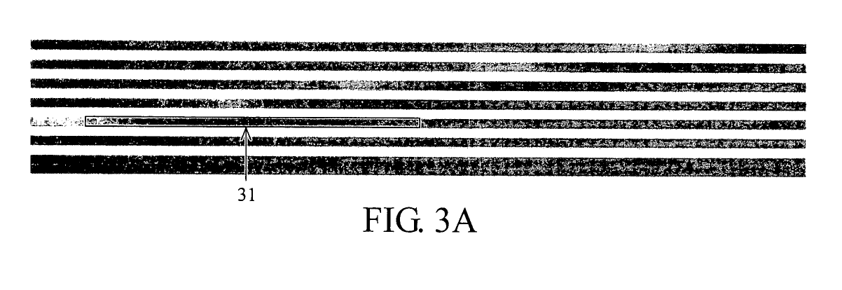

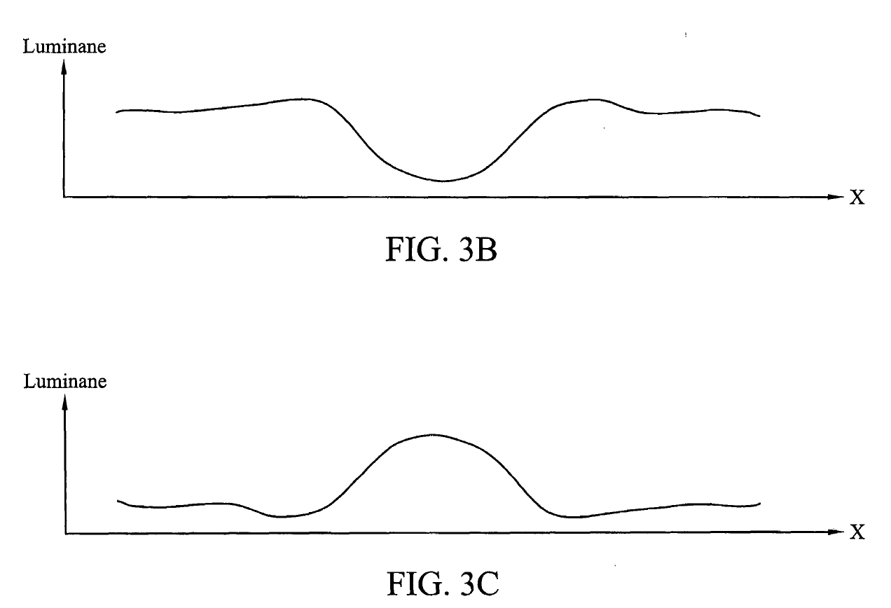

FIG. 3A is an enlarged drawing of a black oblique line extending from lower left to upper right in a white background, and FIG. 3B shows luminance distribution of a region 31 on any pixel line within the black oblique line of FIG. 3A. As shown, luminance in the region 31 decreases and then increases from left to right. On the contrary, luminance of a white oblique line also extending from lower left to upper right in a dark background increases and then decreases from left to right, as is shown in FIG. 3C. Such luminance characteristic of oblique lines can be used to improve de-interlacing quality, as is disclosed herein.

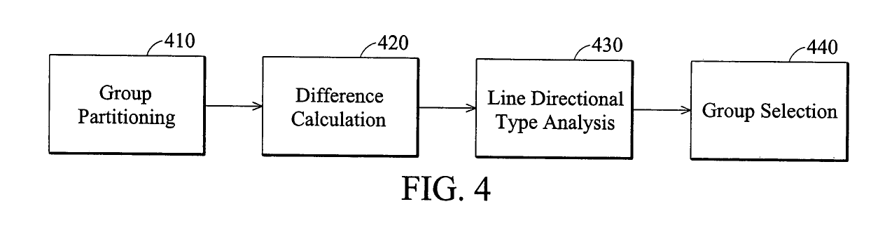

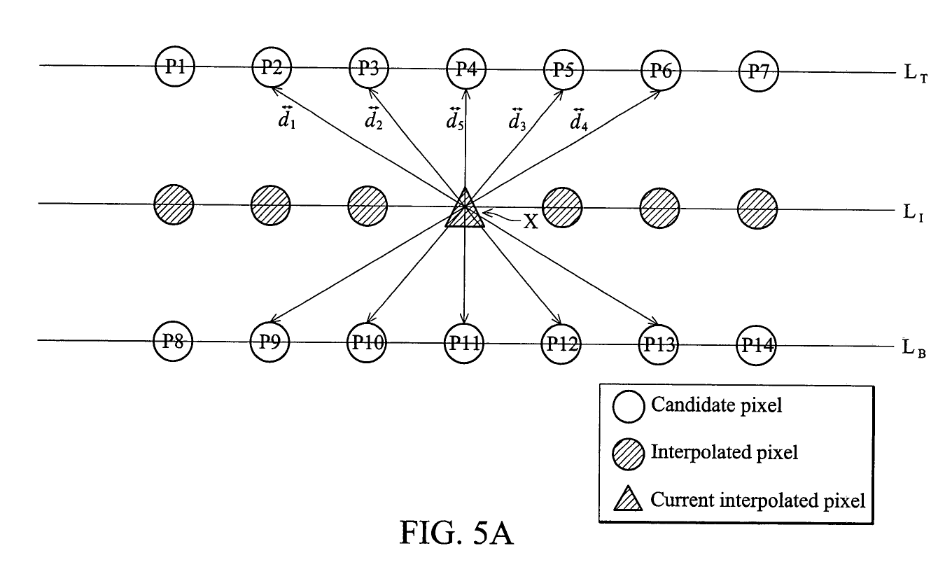

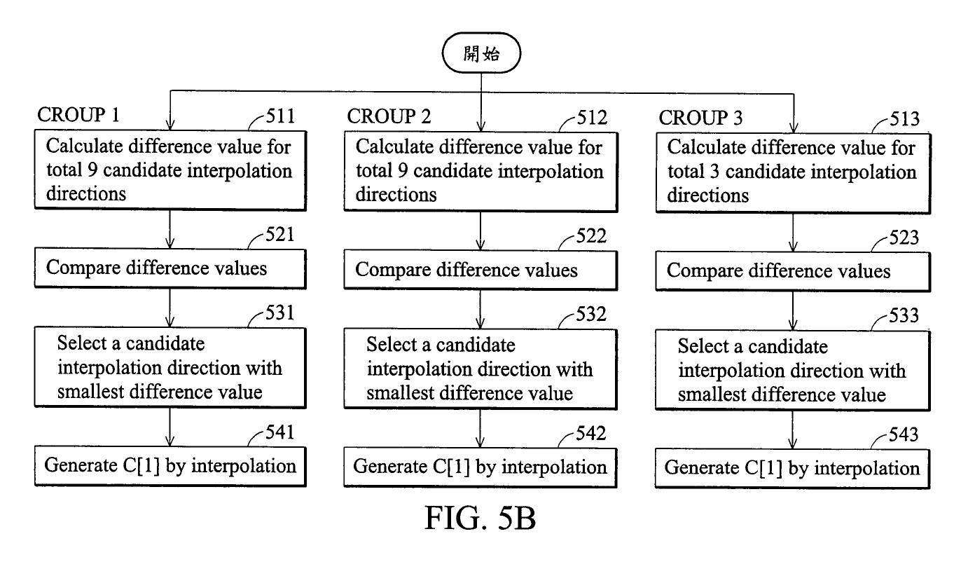

FIG. 4 is a flowchart of an image de-interlacing method in accordance with a first embodiment of the invention. FIG. 5A illustrates step 410. An interlaced Line LI includes interpolated pixels with unknown luminance requiring interpolation with known luminance of two candidate interpolation pixels selected from a top line L_{T} and a bottom line L_{B}, if X is a current interpolated pixel to be interpolated with N1 (N1=7) first candidate interpolation pixels P1 to P7 on the top line L_{T} and N2 (N2=7) second candidate interpolation pixels P8 to P14 on the bottom line L_{B}.

In step 410, N (for example, N=21, 33 or 49) candidate interpolation directions are selected (not all shown), each extending from one of the first candidate interpolation pixels P1 to P7 and one of the second candidate interpolation pixels P8 to P14. Next, the N candidate interpolation directions are classified into first, second, and third directional groups according to relative positions of the first and second candidate interpolation pixels thereof. The candidate interpolation directions having the first candidate interpolation pixels located at the upper left of the second candidate interpolation pixels, such as [symbol] ₁ and [symbol] ₂, are classified into the first directional group. The candidate interpolation directions having the first candidate interpolation pixels located at the upper right of the second candidate interpolation pixels, such as [symbol] ₃ and [symbol] ₄, are classified into the second directional group. The candidate interpolation directions having the first candidate interpolation pixels located at the upper middle of the second candidate interpolation pixels, such as [symbol] ₅, are classified into the third directional group. In an embodiment where N=21, the first, second and third directional groups respectively contain 9, 9, and 3 candidate interpolation directions.

Next, step 420 calculates respective interpolation luminance for each of the directional groups. FIG. 5B is a flowchart of step 420. As shown, in steps 511, 512 and 513, difference values for all of the candidate interpolation directions in the first, second and third directional groups are respectively calculated. It is noted that the difference values of a candidate interpolation direction are not limited to luminance difference between the first and second candidate interpolation pixels of candidate interpolation direction, and various calculation methods of the difference value can be used. Next, in steps 521, 522, and 523, the difference values are compared in the first, second and third directional groups, respectively. Next, in step 531, 532, and 533, the candidate directions with the smallest difference values are selected in the first, second and third directional groups, respectively. In steps 541, 542, and 543, a first interpolation luminance C[1], a second interpolation luminance C[2], and a third interpolation luminance and C[3] are generated in the first, second and third directional groups, respectively.

Next, in steps 430 and 440, the first, the second or all of the directional groups are selected to acquire the interpolation luminance of the interpolated pixel X.

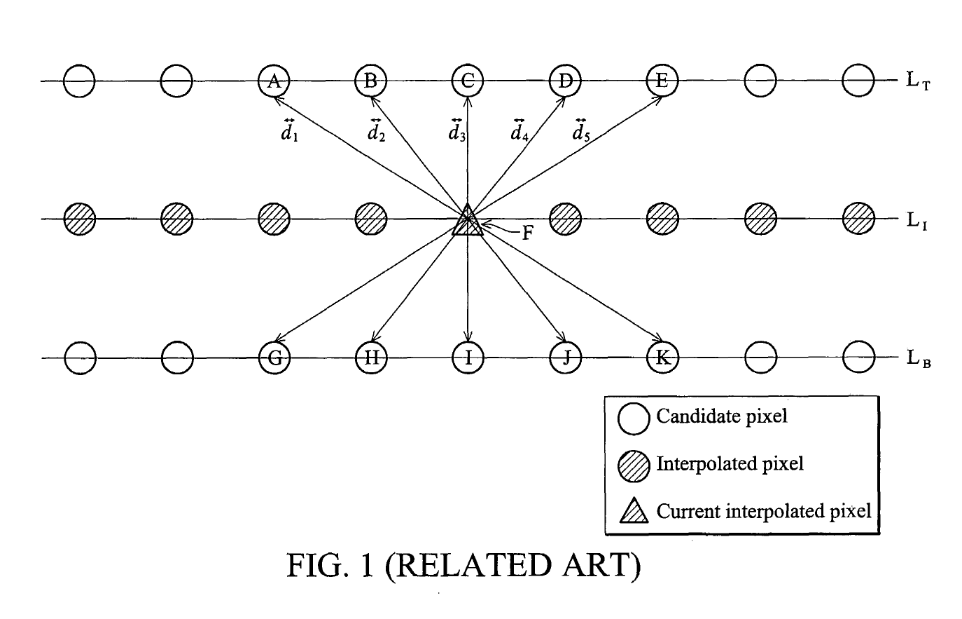

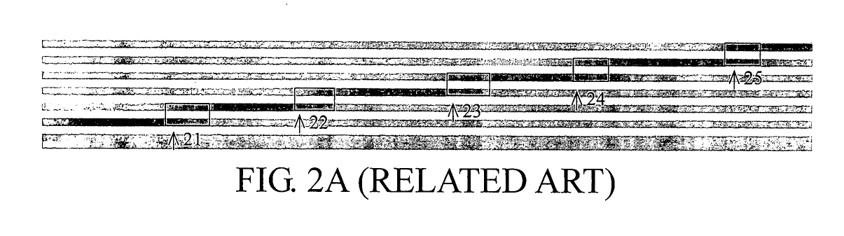

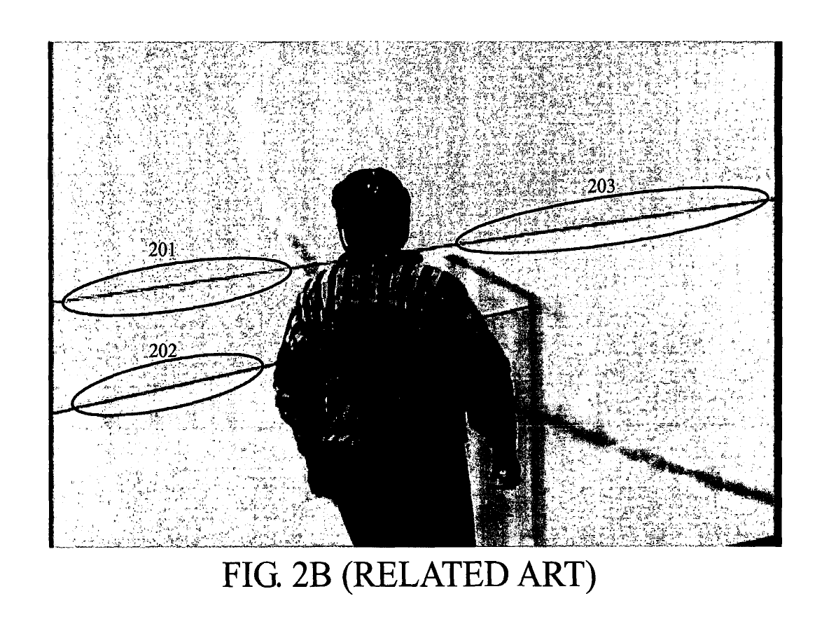

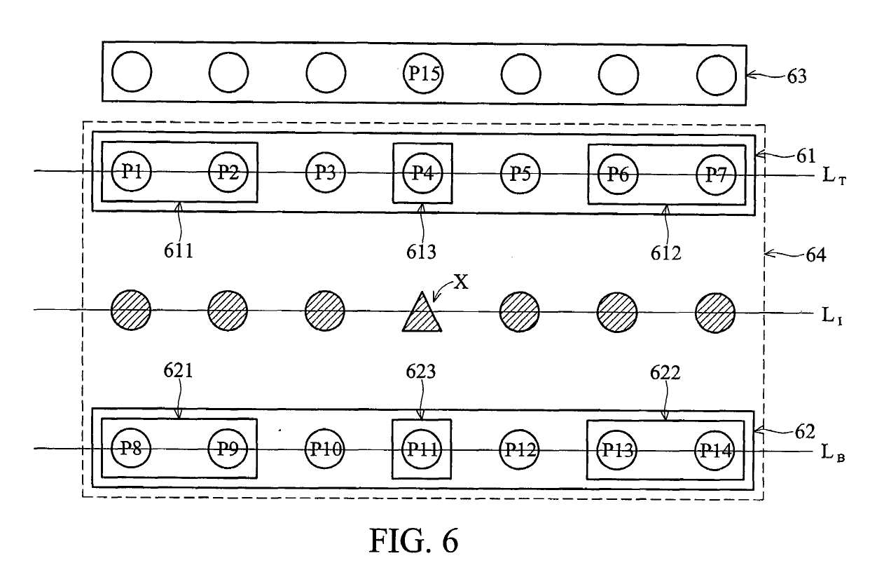

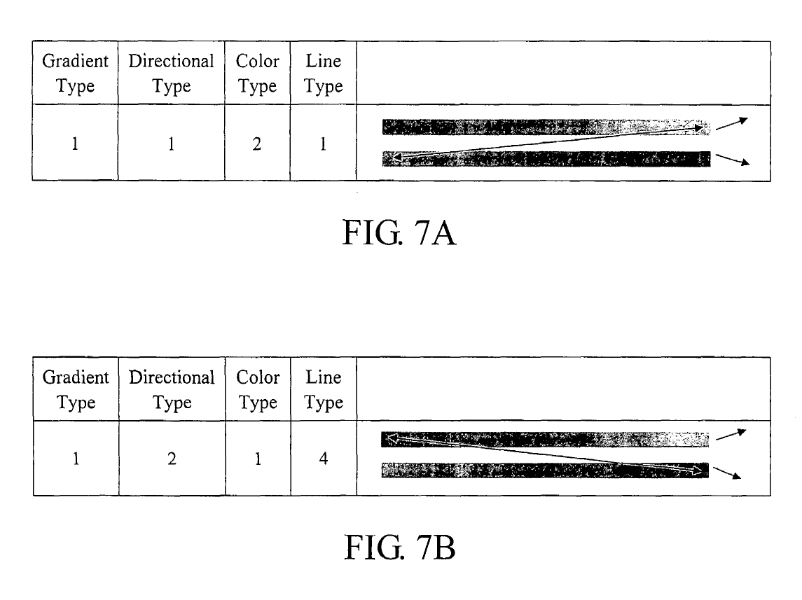

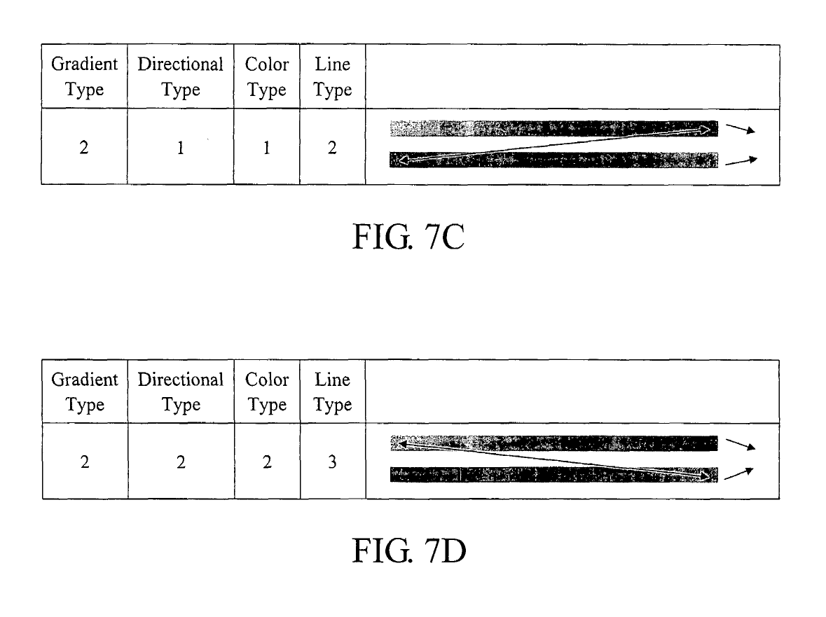

FIGS. 6 and 7 illustrate step 430. Referring also to FIG. 1, in step 430, whether a first observation region 61 and a second observation region 62 are present in an ambiguous area of an oblique line is determined. Referring back to FIG. 2A, ambiguous areas 21-25 reside around interfaces of two segments of the oblique line, wherein the two segments locate on two neighboring pixel lines. If the first and second observation regions 61 and 62 are in an ambiguous area of an oblique line, whether the oblique line inclines from upper right to lower left (directional type 1) or from upper left to lower right (directional type 2) is further determined. As shown in FIG. 6, the first observation region 61 is a segment of the top line L_{T} comprising the first candidate interpolation pixels P1 to P7, and similarly, the first observation region 62 is a segment of the bottom line L_{B} comprising the second candidate interpolation pixels P8 to P14. Note that the first and second observation regions 61 and 62 need not include only the first and second candidate interpolation pixels P1-P7 and P8 to P14, respectively, and can extend horizontally and/or perpendicularly. Preferably, both first and second observation regions 61 and 62 have middle pixels aligned with the interpolated pixel X.

In an embodiment, determination of whether the first and second observation regions are present in an ambiguous area of an oblique line is carried out by checking whether the first observation region 61 and the second observation region 62 respectively have ascending and descending luminance patterns or respectively have descending and ascending luminance patterns. An ascending pattern of a region is defined as: for any two adjacent pixels pᵢ and pᵢ₊₁, luminance l(pᵢ₊₁) on the right pᵢ₊₁ and luminance l(pᵢ) on the left pᵢ always satisfy l(pᵢ₊₁)−l(pᵢ)≧L_{P}, where L_{P} denotes a predetermined luminance difference value. In other words, luminance increases from left to right at a rate exceeding the predetermined luminance difference between two adjacent pixels. Conversely, a descending pattern of the region is defined as: luminance l(pᵢ₊₁) on the right pᵢ₊₁ and luminance l(pᵢ) on the left pᵢ always satisfying l(pᵢ)−l(pᵢ₊₁)≧L_{P}. In other words, luminance increases from right to left at a rate exceeding the predetermined luminance difference between two adjacent pixels.

If the first and second observation regions respectively have ascending and descending luminance patterns or respectively have descending and ascending luminance patterns, the first and second observations are determined to be present in an ambiguous area of an oblique line; otherwise, the first and second observations are determined not to be present in an ambiguous area of an oblique line. Determination of whether the first and second observation regions are present in an ambiguous area of an oblique line can be achieved by checking whether the first and second observation regions 61 and 62 respectively have ascending and descending luminance patterns or respectively have descending and ascending luminance patterns is readily recognized with references to FIGS. 2A and 3A-3C using an oblique black line.

FIGS. 7A to 7D are enlarged drawings of ambiguous areas of oblique lines with all possible combinations of directional types and color types to illustrate applicability of the determination to all line types. When the first and second observation regions 61 and 62 are respectively on an oblique line with directional type 1 (i.e. inclining from upper right to lower left) and color type 2 (defined as the luminance of the oblique line is relatively high compared with the background) as shown in FIG. 7A or an oblique line with directional type 2 (i.e. inclining from upper left to lower right) and color type 1 (defined as the luminance of the oblique line is relatively low compared with the background) as shown in FIG. 7B, the first and second observation regions 61 and 62 respectively have ascending and descending luminance patterns. Conversely, when the first and second observation regions 61 and 62 are respectively on an oblique line with directional type 1 and color type 1 as shown in FIG. 7C or an oblique line with directional type 2 and color type 2 as shown in FIG. 7D, the first and second observation regions 61 and 62 respectively have descending and ascending luminance patterns. The first and second observation regions 61 and 62 in FIGS. 7A, 7B, 7C and 7D are respectively referred to as line types 1, 4, 2 and 3. The first and second observation regions 61 and 62 are referred to as gradient type 1 in FIGS. 7A and 7B and gradient type 2 in FIGS. 7C and 7D. Since FIGS. 7A to 7D show all possible combinations of directional type and color type for oblique lines, when neither the first observation region 61 nor the second observation region 62 t respectively have ascending and descending luminance patterns nor do not respectively have descending and ascending luminance patterns, the first and second observation regions 61 and 62 are not located in an ambiguous area of an oblique line (referred to as line type 5).

In an embodiment, determination of whether the oblique line inclines from upper right to lower left (i.e. directional type 1) or from upper left to lower right (i.e. directional type 2) is carried out by satisfaction of the formula:

{[(diff3>REF_TH) and (diff1>diff2)] or [(diff3≦REF_TH) and (diff1≦diff2)]},

where diff1, diff2 and diff3 respectively denote a first absolute difference, a second absolute difference, and a third absolute difference, defined as:

$$diff 1 = \vert {l}_{BG} - {l}_{AVG 1} \vert$$

$$diff 2 = \vert {l}_{BG} - {l}_{AVG 2} \vert , \\ diff 3 = \vert {l}_{BG} - {l}_{AVG 3} \vert$$

where l_{BG} denotes a background luminance, and l_{AVG1}, l_{AVG2}, and l_{AVG3} respectively denote first, second, and third observation luminances to be defined with reference to FIG. 6. If the formula is satisfied, the oblique line is determined to incline from upper left to lower right; or otherwise, the oblique line is determined to incline from upper right to lower left.

Referring to FIG. 6, the background luminance l_{BG} is determined according to luminance of a background region 63 adjacent to the first and second observation regions 61 and 62. For example, if the background luminance l_{BG} is the average or medium luminance of the background region 63, preferably, the background region 63 is higher than the first observation region 61. Note that the background region 63 need not include only pixels shown in the figure and can be extended or contracted horizontally and upward as long as it is located outside an entire observation region. In an embodiment, the background region 63 is a pixel P15 adjacent to the first observation region 61 and aligned with the middle pixel P4.

The first, second and third observation luminances l_{AVG1}, l_{AVG2}, and l_{AVG3} are defined as:

$${l}_{AVG 1} = \frac{( {l}_{L 1} + {L}_{R 2} )}{2} , {l}_{AVG 2} = \frac{( {l}_{R 1} + {L}_{L 2} )}{2} , and {l}_{AVG 3} = \frac{( {l}_{C 1} + {L}_{C 2} )}{2} ,$$

where l_{L1}, l_{R1} and l_{C1} respectively denote average luminance (or medium luminance) of a left portion 611 (such as pixels P1 and P2), a right portion 612 (such as pixels P6 and P7) and a central portion 613 (such as pixel P4) of the first observation region 61, and l_{L2}, l_{R2}, and l_{C2} respectively denotes average luminance (or medium luminance) of a left portion 621 (such as pixels P8 and P9), a right portion 622 (such as pixels P13 and P14), and a central portion 623 (such as pixel P11) of the second observation region 62. In another embodiment, the left portions 611 and 621 are leftmost pixels P1 and P8 of the first and second observation regions 61 and 62 respectively, the right portions 612 and 622 are rightmost pixels P7 and P14 of the first and second observation regions 61 and 62 respectively, and the central portions 613 and 623 are middle pixels P4 and P11 of the first and second observation regions 61 and 62 respectively.

When (diff3>REF_TH) is satisfied, indicating the difference between the average luminance of the background region and that of the central regions 613 and 623 exceeds a predetermined degree, the direction of the oblique line (from upper right to lower left or from upper left to lower right) is the extension direction of the two regions with average luminance difference exceeding the average difference of the background region 63. Conversely, when (diff3≦REF_TH) is satisfied, indicating the difference between the average luminance of the background region and that of the central regions 613 and 623 is less than a predetermined degree, the direction of the oblique line (from upper right to lower left or from upper left to lower right) is the extension direction of the two regions with average luminance differing less from the average difference of the background region 63.

Referring to FIG. 4, after step 430 is completed, in step 440 the first, the second, or all of the directional groups are selected according to the result of step 430. In step 440, the first interpolation luminance C[1] generated by the first group is selected as the interpolation luminance of the interpolated pixel X if the first and second observation regions 61 and 62 are determined to be present in an ambiguous area of an oblique line of the first directional type, the second interpolation luminance C[2] generated by the second group is selected as the interpolation luminance of the interpolated pixel X if the first and second observation regions 61 and 62 are determined to be present in an ambiguous area of an oblique line of the second directional type, and the smallest of the interpolation luminances C[1], C[2] and C[3] generated by all of the directional groups is selected as the interpolation luminance of the interpolated pixel X if the first and second observation regions 61 and 62 are determined not to be present in any ambiguous area of any oblique line.

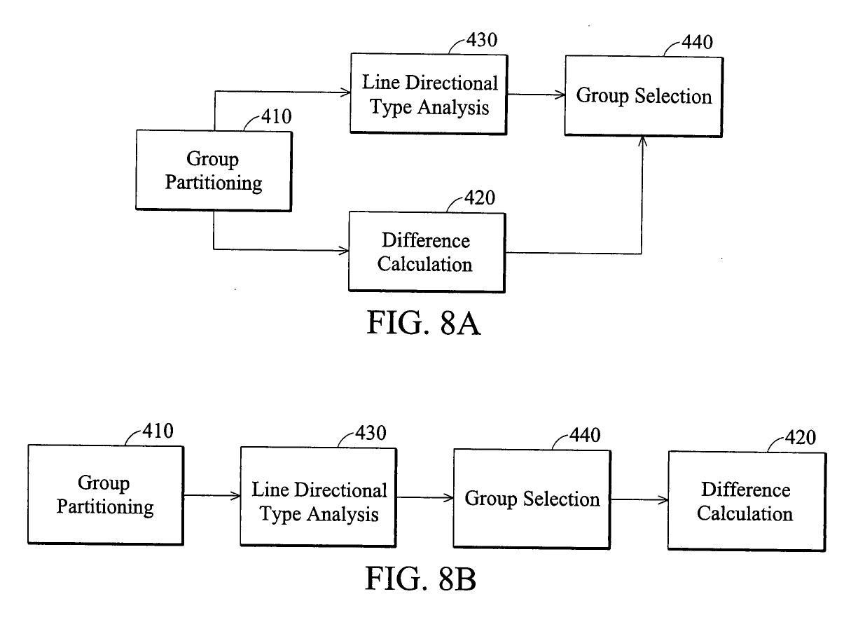

Step 420 need not be performed between steps 410 and 430. FIGS. 8A and 8B are flowcharts of image de-interlacing methods in accordance with second and third embodiments of the invention respectively. In FIG. 8A, steps 420 and 430 are performed simultaneously. In FIG. 8B, step 440 only one or all of the groups is selected, and step 420 is performed in following step 440 to calculate interpolation luminance of the selected group(s).

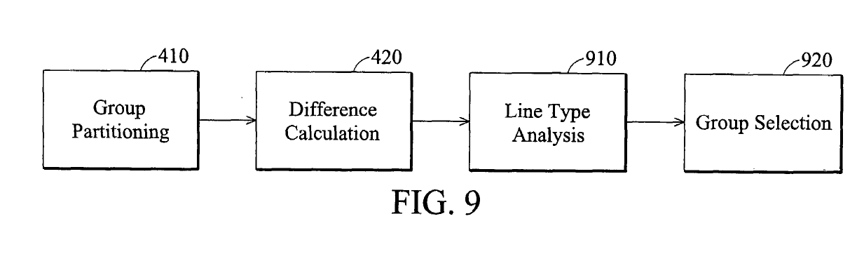

FIG. 9 is a flowchart of an image de-interlacing method in accordance with a fourth embodiment of the invention, differing from FIG. 4 in that step 430 is replaced with step 910 in which not only directional type but also color type of an oblique line where the first and second observations 61 and 62 located are both analyzed to obtain a line type of the oblique line, and step 440 is also replaced with step 920 to consider the line type rather than directional type in selecting directional group(s). Steps 410 and 420 are described in connection with FIG. 4 and are thus omitted here for brevity.

In step 910, whether the first and second observation regions 61 and 62 are present in an ambiguous area of an oblique line are determined. If not, the oblique line is determined to be a fifth line type. If so, whether the oblique line inclines from upper right to lower left (directional type 1) or from upper left to lower right (directional type 2) and whether the luminance of the oblique line is relatively low compared with the background (the first color type) or relatively high compared with the background (the second color type) are both determined. The oblique line is then determined to be a first line type, a second line type, a third line type, or a fourth line type respectively if the (color type, directional type) of the oblique line is (1,2), (1,1), (2,2), or (2,1), as shown in FIGS. 7A-7D.

It is noted that the color type analysis can be replaced with gradient type analysis since gradient type analysis has been performed in step 430 and the gradient analysis can be used directly. In other words, the line type of the oblique line can be determined according to only two of gradient type, directional type, and color type, as is clear in FIGS. 7A-7D.

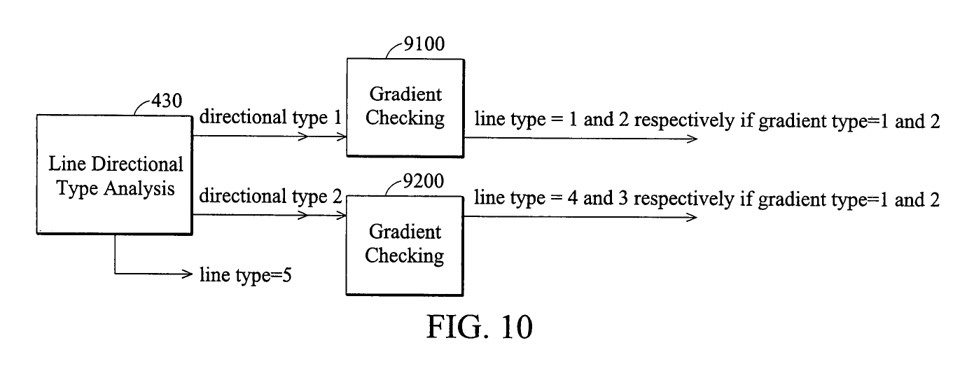

FIG. 10 is a flowchart of step 910 in accordance with such an embodiment of the invention. Step 910 comprises steps 430, 9100 and 9200. Step 430 is described in connection with FIG. 4 and is thus omitted here for brevity. After step 430 is completed, if the first and second observation regions 61 and 62 are not present in an ambiguous area of an oblique line, the line type of the oblique line is determined to be the fifth type. Otherwise, the gradient type and the directional type of the oblique line are determined. Next, steps 9110 and 9200 are performed to determine the line type of the oblique line according to the gradient type and the directional type. As shown, if the oblique line is determined to be directional type 2 in step 430, the oblique line is determined to be line type 1 and 2 respectively if the first and second observation regions 61 and 62 are gradient types 1 and 2. If the oblique line is determined to be directional type 1 in step 430, the oblique line is determined to be line type 4 and 3 respectively if the first and second observation regions 61 and 62 are gradient types 1 and 2.

After the line type of the oblique line is determined in step 910, step 920 is then performed to select one or all of the directional groups based on the line type. If the oblique line is the first or second line type, the first interpolation luminance C[1] of the first directional group is selected as the interpolation luminance of the interpolated pixel X. If the oblique line is the third or fourth line type, the second interpolation luminance C[2] of the second directional group is selected as the interpolation luminance of the interpolated pixel X. If the oblique line is the fifth line type, the smallest of the interpolation luminances C[1], C[2] and C[3] generated by all of the directional groups is selected as the interpolation luminance of the interpolated pixel X.

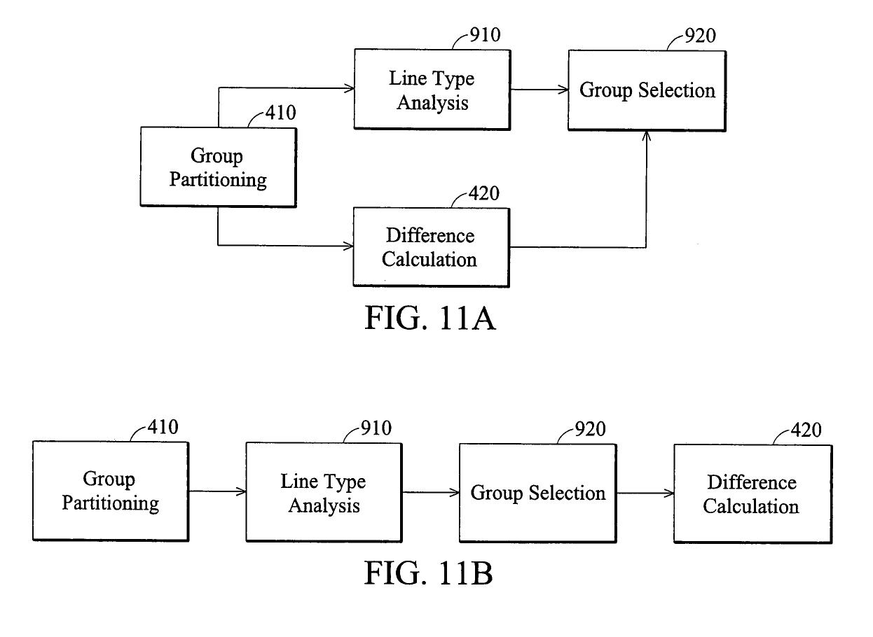

Note that step 420 need not be performed between steps 410 and 920. FIGS. 11A and 11B are flowcharts of image de-interlacing methods in accordance with a fifth and sixth embodiment of the invention respectively. In FIG. 11A, steps 120 and 910 are performed simultaneously. In FIG. 11B, step 920 only selects one or all of the groups, and step 120 is performed in following step 920 to calculate interpolation luminance of the selected group(s).

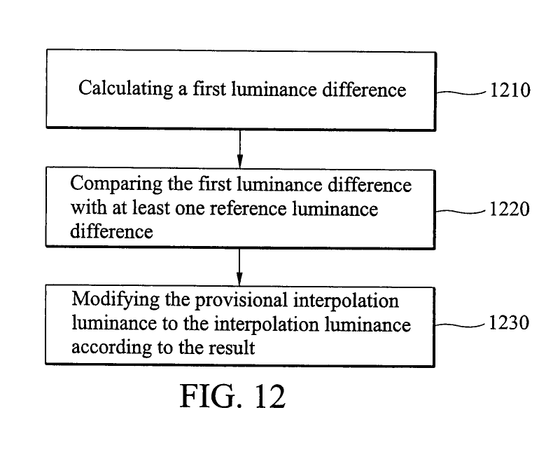

Note that the interpolation luminance of the interpolated pixel obtained using the image interpolation methods of the embodiments can be used as provisional interpolation luminance and further modified to the interpolation luminance of the interpolated pixel X. FIG. 12 is an exemplary flowchart illustrating modification of the provisional interpolation luminance to the interpolation luminance. In step 1210, a first luminance difference l_{D1}=|l_{P}−l_{R}| is calculated, where l_{P} denotes the provisional interpolation luminance and l_{R} denotes a reference luminance. In step 1220, the first directional difference l_{D1} is compared to at least one reference luminance difference. In step 1230, the provisional interpolation luminance l_{P} is modified to the interpolation luminance l(F) according to the comparison result. If the reference directional difference comprises a higher reference luminance l_{RH} and a lower reference luminance l_{RL}, for example, the provisional interpolation luminance B_{P} is modified to the reference luminance l_{R} if the first directional difference ld₁ exceeds the higher reference luminance l_{RH}, to (B_{P}+B_{R})/2 if the first directional difference l_{D1} is between the higher and lower reference luminance l_{RH} and l_{RL}, or is not modified if the first directional difference is less than the lower reference luminance l_{RL}.

Since not all of the candidate interpolation directions are always used to obtain the interpolation luminance of the interpolated pixel X, erroneous judgment of the candidate interpolation direction with highest correlation is greatly reduced in recovery of oblique lines. As such, fewer interpolation candidate interpolation directions (for example, 21 compared with 49) need be used compared to conventional methods, with interpolation quality still enhanced.

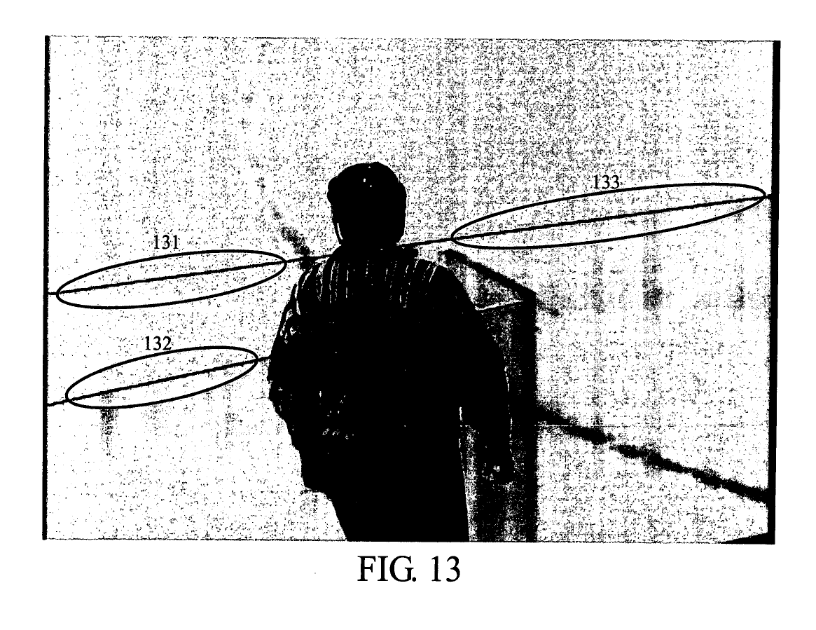

FIG. 13 illustrates an image recovered using an image interpolation method of the invention. Comparing regions 131, 132 and 133 respectively with regions 201, 202 and 203 in FIG. 2B where image recovery is realized using a conventional ELA method, it is clear that white dots on ambiguous areas in FIG. 2B are not present in FIG. 13B.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An image de-interlacing method for estimating an interpolation luminance of an interpolated pixel, comprising:
selecting a plurality of candidate interpolation directions extending from one of a plurality of first candidate interpolation pixels to one of a plurality of second candidate interpolation pixels respectively on top and bottom lines adjacent to the interpolated pixel;
classifying the candidate interpolation directions into first, second, and third directional groups, wherein the first, second, and third directional groups respectively comprise the candidate interpolation directions having the first candidate interpolation pixels located at the upper left, upper right, and upper middle of the second candidate interpolation pixel respectively; selecting at least one of the directional groups to obtain the interpolation luminance of the interpolated pixel.

2. The image de-interlacing method as claimed in claim 1, wherein selection of at least one of the directional groups to obtain the interpolation luminance of the interpolated pixel comprises:
determining whether a first observation region higher than the interpolated pixel and a second observation region lower than the interpolated pixel are present in an ambiguous area of an oblique line, wherein the ambiguous area is located around an interface of two segments of the oblique line, wherein the two segments locate on two neighboring pixel lines; and
selecting at least one of the directional groups according to the determination result.

3. The image de-interlacing method as claimed in claim 2, wherein selection of at least one of the directional groups according to the determination result comprises:
if the first and second observation regions are present in an ambiguous area of an oblique line, determining a directional type of the oblique line, and selecting at least one of the directional groups according to the directional type of the oblique line.

4. The image de-interlacing method as claimed in claim 2, wherein selection of at least one of the directional groups according to the determination result comprises:
if the first and second observation regions are not present in an ambiguous area of an oblique line, selecting all of the directional groups to obtain the interpolation luminance of the interpolated pixel.

5. The image de-interlacing method as claimed in claim 3, wherein determination of the directional type of the oblique line comprises determining whether the oblique line is a first directional type extending from upper right to lower left or a second directional type extending from upper left to lower right.

6. The image de-interlacing method as claimed in claim 5, wherein selection the at least one of the directional groups according to the directional type of the oblique line comprises selecting the first or second directional groups to obtain the interpolation luminance of the interpolated pixel respectively if the oblique line is the first or second directional type.

7. The image de-interlacing method as claimed in claim 2, wherein determination of whether the first and second observation regions are present in an ambiguous area of an oblique line comprises determining whether the first and second observation regions respectively have ascending and descending luminance patterns or respectively have descending and ascending luminance patterns; and determining the first and second observation regions are present in an ambiguous area of an oblique line if so, or otherwise determining the first and second observation regions are not present in an ambiguous area of an oblique line.

8. The image de-interlacing method as claimed in claim 5, wherein determination of whether the oblique line is the first or second directional type comprises:
calculating a first absolute difference between a background luminance and a first average observation luminance, wherein the background luminance is determined according to luminance of a background region adjacent to the first and second observation regions, and wherein the first observation luminance is determined by a left portion of the first observation region and a right portion of the second observation region.
calculating a second absolute difference between the background luminance and a second average observation luminance, wherein the second observation luminance is determined by a right portion of the first observation region and a left portion of the second observation region;
calculating a third absolute difference between the background luminance and a third average observation luminance, wherein the third observation luminance is determined by a central portion of the first observation region and a central portion of the second observation region; and
determining whether the oblique line is the first or second directional type according to the first, second and third luminance differences.

9. The image de-interlacing method as claimed in claim 8, wherein the background luminance is an average luminance of the background region.

10. The image de-interlacing method as claimed in claim 8, wherein the first observation luminance is an average luminance of the left portion of the first observation region and the right portion of the second observation region, the second observation luminance is an average luminance of the right portion of the first observation region and the left portion of the second observation region, and the third observation luminance is an average luminance of the central portion of the first observation region and the central portion of the second observation region.

11. The image de-interlacing method as claimed in claim 8, wherein determination of whether the oblique line is the first or second directional type according to the first, second and third luminance differences comprises determining whether or, where, and are respectively the first, second and third luminance differences, and is a predetermined threshold luminance; and determining the oblique line to be the second directional type if so, or otherwise, determining the oblique line to be the first directional type.

12. The image de-interlacing method as claimed in claim 8, wherein the background region is higher than the first observation region.

13. The image de-interlacing method as claimed in claim 11, wherein the background region is a pixel adjacent to the first observation region and aligned with middle pixels of the first and second observation regions.

14. The image de-interlacing method as claimed in claim 2, wherein the first and second observation region are respectively segments of the top line and bottom line comprising the first and second candidate interpolation pixels and having middle pixels aligned with the interpolated pixel.

15. The image de-interlacing method as claimed in claim 8, wherein the left portions of the first and second observation region are the leftmost pixels thereof respectively, the right portions of the first and second observation region are the rightmost pixels thereof respectively, and the central portions of the first and second observation region are the middle pixels thereof respectively.

16. The image de-interlacing method as claimed in claim 3, wherein in selection of at least one of the directional groups according to the determination result, if the first and second observation regions are present in an ambiguous area of an oblique line, a color type of the oblique line is further determined, and selection of the at least one of the directional groups is further according to the color type of the oblique line.

17. The image de-interlacing method as claimed in claim 5, wherein in selection of at least one of the directional groups according to the determination result, if the first and second observation regions are present in an ambiguous area of an oblique line, whether the oblique line is a first color type or a second color type is further determined, and selection of the at least one of the directional groups is further according to the color type of the oblique line, wherein the oblique line is the first or second color type respectively if the luminance of the oblique line is relatively low or high compared to a background region adjacent to the oblique line.

18. The image de-interlacing method as claimed in claim 17, wherein selection of the at least one of the directional groups according to the directional type and the color type of the oblique line comprise:
selecting the first directional group to obtain the interpolation luminance of the interpolated pixel if the oblique line is a first or a second line type; and
selecting the second directional group to obtain the interpolation luminance of the interpolated pixel if the oblique line is a third or a fourth line type,
wherein the oblique line is the first line type, the second line type, the third line type, and the fourth line type respectively if it is the first directional type and the second color type, the first directional type and the first color type,
the second directional type and the second color type, and the second directional type and the first color type.

19. The image de-interlacing method as claimed in claim 3, wherein in selection of at least one of the directional groups according to the determination result, if the first and second observation regions are present in an ambiguous area of an oblique line, a gradient type of the oblique line is further determined according to luminance patterns of the first and second observation regions, and selection of the at least one of the directional groups is further according to the gradient type of the oblique line.

20. The image de-interlacing method as claimed in claim 5, wherein in selection of at least one of the directional groups according to the determination result, if the first and second observation regions are present in an ambiguous area of an oblique line, whether the oblique line is a first gradient type or a second gradient type is further determined, and selection of the at least one of the directional groups is further according to the gradient type of the oblique line, wherein the oblique line is a first gradient type if the first and second observation regions respectively have ascending and descending luminance patterns and is a second gradient type if the first and second observation regions respectively have descending and ascending luminance patterns.

21. The image de-interlacing method as claimed in claim 17, wherein selection of at least one of the directional groups according to the directional type and the gradient type of the oblique line comprises:
selecting the first directional group to obtain the interpolation luminance of the interpolated pixel if the oblique line is a first or a second line type; and
selecting the second directional group to obtain the interpolation luminance of the interpolated pixel if the oblique line is a third or a fourth line type,
wherein the oblique line is the first line type, the second line type, the third line type, and the fourth line type respectively when it is the first directional type and the first gradient type, the first directional type and the second gradient type, the second directional type and the second gradient type, and the second directional type and the first gradient type.

22. An image de-interlacing method for estimating an interpolation luminance of an interpolated pixel, comprising:
selecting a plurality of candidate interpolation directions extending from one of a plurality of first candidate interpolation pixels to one of a plurality of second candidate interpolation pixels respectively on top and bottom lines adjacent to the interpolated pixel;
determining whether a first observation region higher than the interpolated pixel and a second observation region lower than the interpolated pixel are present in an ambiguous area of an oblique line, wherein the ambiguous area is located around an interface of two segments of the oblique line,
wherein the two segments locate on two neighboring pixel lines;
selecting a group of directions from the candidate interpolation directions according to the determination result; and
obtaining the interpolation luminance of the interpolated pixel according to the group of directions.

23. The image de-interlacing method as claimed in claim 22, wherein selection of the group of directions from the candidate interpolation directions according to the determination result comprises: if the first and second observation regions are present in an ambiguous area of an oblique line, determining a directional type of the oblique line, and selecting the group of directions according to the directional type of the oblique line.

24. The image de-interlacing method as claimed in claim 23, wherein determination of the directional type of the oblique line comprises determining whether the oblique line is a first directional type extending from upper right to lower left or a second directional type extending from upper left to lower right.

25. The image de-interlacing method as claimed in claim 24, wherein selection of the group of directions according to the directional type of the oblique line comprises selecting the group of directions respectively as the candidate interpolation directions having the first candidate interpolation pixels located at the upper left or upper right of the second candidate interpolation pixel respectively if the oblique line is the first or second directional type.

26. The image de-interlacing method as claimed in claim 22, wherein selection of the group of directions from the candidate interpolation directions according to the determination result comprises selecting the group of directions as all of the candidate interpolation directions if the first and second observation regions are not present in an ambiguous area of an oblique line.

27. The image de-interlacing method as claimed in claim 22, wherein determination of whether the first and second observation regions are present in the ambiguous area of the oblique line comprises determining whether the first and second observation regions respectively have ascending and descending luminance patterns or respectively have descending and ascending luminance patterns; and determining the first and second observation regions are on the oblique line if so, or otherwise determining the first and second observation regions are not on the oblique line.

28. The image de-interlacing method as claimed in claim 24, wherein determination of whether the oblique line is the first or second directional type comprises:
calculating a first absolute difference between a background luminance and a first average observation luminance, wherein the background luminance is determined according to luminance of a background region adjacent to the first and second observation regions, and wherein the first observation luminance is determined by a left portion of the first observation region and a right portion of the second observation region;
calculating a second absolute difference between the background luminance and a second average observation luminance, wherein the second observation luminance is determined by a right portion of the first observation region and a left portion of the second observation region;
calculating a third absolute difference between the background luminance and a third average observation luminance, wherein the third observation luminance is determined by a central portion of the first observation region and a central portion of the second observation region; and
determining whether the oblique line is the first or second directional type according to the first, second and third luminance differences.

29. The image de-interlacing method as claimed in claim 28, wherein the background luminance is an average luminance of the background region.

30. The image de-interlacing method as claimed in claim 28, wherein the first observation luminance is an average luminance of the left portion of the first observation region and the right portion of the second observation region, the second observation luminance is an average luminance of the right portion of the first observation region and the left portion of the second observation region, and the third observation luminance is an average luminance of the central portion of the first observation region and the central portion of the second observation region.

31. The image de-interlacing method as claimed in claim 28, wherein determination of whether the oblique line is the first or second directional type according to the first, second and third luminance differences comprises determining whether or, where, and are respectively the first, second and third luminance differences, and is a predetermined threshold luminance; and determining the oblique line to be the second directional type if so, or otherwise, determining the oblique line to be the first directional type.

32. The image de-interlacing method as claimed in claim 28, wherein the background region is higher than the first observation region.

33. The image de-interlacing method as claimed in claim 32, wherein the background region is a pixel adjacent to the first observation region and aligned with middle pixels of the first and second observation regions.

34. The image de-interlacing method as claimed in claim 22, wherein the first and second observation region are respectively segments of the top line and bottom line comprising the first and second candidate interpolation pixels and having middle pixels aligned with the interpolated pixel.

35. The image de-interlacing method as claimed in claim 28, wherein the left portions of the first and second observation region are the leftmost pixels thereof respectively, the right portions of the first and second observation region are the rightmost pixels thereof respectively, and the central portions of the first and second observation region are the middle pixels thereof respectively.

36. The image de-interlacing method as claimed in claim 23, wherein in selection of the group of directions from the candidate interpolation directions according to the determination result, if the first and second observation regions are present in an ambiguous area of an oblique line, a color type of the oblique line is further determined, and selection of the group of directions is further according to the color type of the oblique line.

37. The image de-interlacing method as claimed in claim 24, wherein in selection of the group of directions from the candidate interpolation directions according to the determination result, if the first and second observation regions are present in an ambiguous area of an oblique line, whether the oblique line is a first color type or a second color type is further determined, and selection of the group of directions is further according to the color type of the oblique line, wherein the oblique line is the first or second color type respectively if the luminance of the oblique line is relatively low or high compared to a background region adjacent to the oblique line.

38. The image de-interlacing method as claimed in claim 37, wherein selection of the group of directions according to the directional type and the color type of the oblique line comprises:
selecting the candidate interpolation directions having the first candidate interpolation pixels located at the upper left of the second candidate interpolation pixel as the group of directions if the oblique line is a first or a second line type; and
selecting the candidate interpolation directions having the first candidate interpolation pixels located at the upper right of the second candidate interpolation pixel as the group of directions if the oblique line is a third or a fourth line type,
wherein the oblique line is the first line type, the second line type, the third line type, and the fourth line type respectively if it is the first directional type and the second color type, the first directional type and the first color type, the second directional type and the second color type, and the second directional type and the first color type.

39. The image de-interlacing method as claimed in claim 23, wherein in selection of the group of directions from the candidate interpolation directions according to the determination result, if the first and second observation regions are present in an ambiguous area of an oblique line, a gradient type of the oblique line is further determined according to luminance patterns of the first and second observation regions, and selection of the group of directions is further according to the gradient type of the oblique line.

40. The image de-interlacing method as claimed in claim 24, wherein in selection of the group of directions from the candidate interpolation directions according to the determination result, if the first and second observation regions are present in an ambiguous area of an oblique line, whether the oblique line is a first gradient type or a second gradient type is further determined, and selection of the group of directions is further according to the gradient type of the oblique line, wherein the oblique line is a first gradient type if the first and second observation regions respectively have ascending and descending luminance patterns and is a second gradient type if the first and second observation regions respectively have descending and ascending luminance patterns.

41. The image de-interlacing method as claimed in claim 40, wherein election of the group of directions according to the directional type and the color type of the oblique line comprises:
selecting the candidate interpolation directions having the first candidate interpolation pixels located at the upper left of the second candidate interpolation pixel as the group of directions if the oblique line is a first or a second line type; and
selecting the candidate interpolation directions having the first candidate interpolation pixels located at the upper right of the second candidate interpolation pixel as the group of directions if the oblique line is a third or a fourth line type,
wherein the oblique line is the first line type, the second line type, the third line type, and the fourth line type respectively when it is the first directional type and the first gradient type, the first directional type and the second gradient type, the second directional type and the second gradient type, and the second directional type and the first gradient type.
